(19) United States
(12) Patent Application Publication
(10) Pub. No.: US 2021/0321158 A1
(43) Pub. Date: Oct. 14, 2021

(54) BROADCASTING METHOD AND SYSTEM FOR AUTOMATICALLY GENERATING COVER SCREEN AND BROADCASTING VIDEO CORRESPONDING THERETO

(71) Applicant: SK STOA CO., LTD., Seoul (KR)

(72) Inventor: Dae Ho MYOUNG, Seoul (KR)

(73) Assignee: SK STOA CO., LTD., Seoul (KR)

(21) Appl. No.: 17/226,664

(22) Filed: Apr. 9, 2021

(30) Foreign Application Priority Data
Apr. 9, 2020 (KR) 10-2020-0043614

(51) Int. Cl. H04N 21/431; H04N 21/478; H04N 21/488; H04N 21/84; H04N 21/81

(52) U.S. Cl. CPC H04N 21/4316; H04N 21/47815; H04N 21/8146; H04N 21/84; H04N 21/4882

(57) ABSTRACT

A method of automatically generating a cover screen and a broadcasting video includes obtaining a user input, requesting cover screen data corresponding to the user input and broadcasting video data corresponding to the user input, generating the cover screen data using a media cloud server, and selecting the broadcasting video data using a content server.

### CROSS-REFERENCE TO RELATED APPLICATION

This application is based on and claims priority under 35 U.S.C. § 119 to Korean Patent Application No. 10-2020-0043614, filed on Apr. 9, 2020, in the Korean Intellectual Property Office, the disclosure of which is incorporated by reference herein in its entirety.

### BACKGROUND

### 1. Field

The present disclosure relates to a broadcasting method and system for automatically generating a cover screen and a broadcasting video corresponding thereto.

### 2. Description of the Related Art

With the recent development of TV technology and digital technology, various information is being delivered to viewers through TVs. For example, TV home shopping, which provides shopping information through a TV, provides various information according to technological changes.

Moreover, with the recent commercialization of digital-based digital television technology, it has become possible to provide various contents through a network connected to each home, such as the Internet, and an Internet Protocol Television (IPTV) service is a representative example.

In the IPTV service, various services may be provided to IPTV service subscribers through a set-top box installed in a designated space such as a home and among the various services, a shopping broadcasting service (or commerce broadcasting) provided through a commerce channel may also be provided.

In the case of a commerce service provider that produces a home or internet shopping broadcasting service, a commerce channel (i.e., a shopping broadcasting service) may be arranged in a channel assigned/promised accordingly by paying a certain amount.

Accordingly, when an IPTV service subscriber selects a channel scheduled in the set-top box, the set-top box receives the commerce channel regularly arranged on that channel and outputs the commerce channel through TV, so that the IPTV service subscriber may watch commerce channels and use shopping broadcasting services. However, convenience for subscribers, such as delivery of various shopping information according to a user's request, confirmation of shopping information, and ordering, may improve.

Meanwhile, as described above, the output of the IPTV is controlled through the set-top box, but an overload may occur on the network connected to the set-top box in response to a request to interwork with various contents such as real-time data according to a user input.

### SUMMARY

The present disclosure is to provide a broadcasting method and system for automatically generating a cover screen and a broadcasting video corresponding thereto according to a user input while distributing data load on a network by using a server different from a set-top box.

Additional aspects will be set forth in part in the description which follows and, in part, will be apparent from the description, or may be learned by practice of the presented embodiments of the disclosure.

According to an embodiment of the present disclosure, a method of automatically generating a cover screen and a broadcasting video includes obtaining a user input, requesting cover screen data corresponding to the user input and broadcasting video data corresponding to the user input, generating the cover screen data using a media cloud server, and selecting the broadcasting video data using a content server.

In at least one variant, the method may further include generating first output data including a cover screen generated based on the cover screen data received from the media cloud server, and generating second output data including a broadcasting video generated based on the broadcasting video data received from the content server.

In another variant, the method may further include a first output step of displaying a cover screen according to the first output data on a TV screen at a first time point, and a second output step of displaying a broadcasting video according to the second output data on the TV screen at a second time point later than the first time point.

In further another variant, the method may further include accessing a control screen through a user terminal; and setting an output data condition for each product code through the control screen, wherein the generating of the first output data and the second output data includes generating the first output data and the second output data based on the output data condition.

According to one or more embodiments of the present disclosure, a broadcasting system that automatically generates a cover screen and a broadcasting video includes a set-top box configured to acquire a user input and request cover screen data corresponding to the user input and broadcasting video data corresponding to the user input, a media cloud server configured to generate the cover screen data in response to the request, and a content server configured to select the broadcasting video data in response to the request.

In at least one variant, the set-top box may output first output data including a cover screen generated based on the cover screen data, and output second output data including a broadcasting video generated based on the broadcasting video data.

In another variant, the set-top box, through an output device connected to the set-top box, may control to display the cover screen according to the first output data in a first area at a first time point, and automatically generate a cover screen and a broadcasting video for controlling to display the broadcasting video according to the second output data in the first area at a second time point later than the first time point.

In further another variant, an output data condition for each product code may be set using the media cloud server, where the set-top box may generate the first output data and the second output data based on the output data condition.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing a configuration of a broadcasting system according to an embodiment of the present disclosure;

FIG. 2 is a diagram showing another configuration of a broadcasting system according to an embodiment of the present disclosure;

FIG. 3 is a flowchart illustrating a method of operating a broadcasting system according to an embodiment of the present disclosure;

FIG. 4 is a flowchart illustrating a method of operating a broadcasting system according to another embodiment of the present disclosure;

FIG. 5 is an exemplary display of output data of a first time point generated by a broadcasting system according to an embodiment of the present disclosure;

FIG. 6 is an exemplary diagram of output data of a second time point generated by a broadcasting system according to an embodiment of the present disclosure; and

FIG. 7 is an exemplary diagram of a control screen for a media cloud server according to an embodiment of the present disclosure.

### DETAILED DESCRIPTION

Reference will now be made in detail to embodiments, examples of which are illustrated in the accompanying drawings, wherein like reference numerals refer to like elements throughout.

In this regard, the present embodiments may have different forms and should not be construed as being limited to the descriptions set forth herein.

Accordingly, the embodiments are merely described below, by referring to the figures, to explain aspects of the present description.

As used herein, the term “and/or” includes any and all combinations of one or more of the associated listed items.

Expressions such as “at least one of,” when preceding a list of elements, modify the entire list of elements and do not modify the individual elements of the list.

Since the present disclosure may apply various modifications and have various embodiments, specific embodiments are illustrated with reference to the drawings and will be described in detail.

Effects and features of the present disclosure, and a method of achieving them will be apparent with reference to the embodiments described below in detail together with the drawings.

However, the present disclosure is not limited to the embodiments disclosed below and may be implemented in various forms.

Hereinafter, embodiments of the present disclosure will be described in detail with reference to the accompanying drawings, and when describing with reference to the drawings, the same or corresponding constituent elements are given the same reference numerals, and redundant descriptions thereof will be omitted.

In the following embodiments, terms such as first and second are not used in a limiting meaning, but for the purpose of distinguishing one component from another component.

In the following examples, the singular expression includes the plural expression unless the context clearly indicates otherwise.

In the following embodiments, terms such as include or have means that the features or elements described in the specification are present, and do not preclude the possibility of adding one or more other features or elements in advance.

In the drawings, components may be exaggerated or reduced in size for convenience of description.

For example, the size and shape of each component shown in the drawings are arbitrarily shown for convenience of description, and thus the present disclosure is not necessarily limited to what is shown.

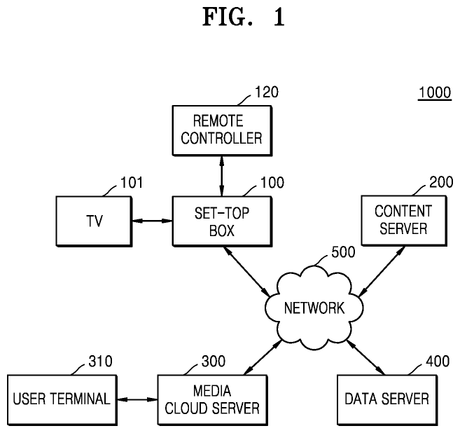

FIG. 1 is a diagram showing a configuration of a broadcasting system 1000 according to an embodiment of the present disclosure.

The broadcasting system 1000 includes a set-top box 100, an output device 101 connected to the set-top box 100, a content server 200, a media cloud server 300, a data server 400, and a user terminal 310 connected to the media cloud server 300, as shown in FIG. 1.

The set-top box 100, the content server 200, the media cloud server 300, and the data server 400 may be connected to each other through a network 500 to communicate with one another.

FIG. 1 shows that the output device 101 is a TV as an example, but the output device 101 is not limited thereto, and includes a smart TV. Additionally, or alternatively, the output device 101 may include various types of electronic devices including a display such as a smart phone or a PMP. Hereinafter, the output device 101 will be referred to as a TV 101.

The set-top box 100 is a hardware device for use in watching satellite broadcasting or cable broadcasting at home.

Data such as satellite broadcasting, cable broadcasting, or Internet broadcasting are transmitted to the set-top box 100 as data processed by compression and modulation, etc. and the set-top box 100 performs a role of performing a process such as demodulation and decompression on the received data so that the data may be implemented in the output device 20.

In another embodiment, the broadcasting system 1000 does not include the content server 200, and a server of a broadcast provider may operate as a content server.

In this embodiment, the broadcasting system 1000 may include the content server 200. In this case, the content server 200 may transmit content to servers of various broadcast providers. The content server 200 may store content such as a broadcasting video suitable for a broadcast provider's platform or format. The content server 200 may provide the stored content to the above-described set-top box 100 so that content such as a broadcasting video may be played on the output device 101.

The set-top box 100 may communicate with the content server 200, the media cloud server 300, and the data server 400 through the network 500.

The set-top box 100 may transmit a control signal and/or an output signal to the output device 101 based on data received from the content server 200 and the media cloud server 300. In some forms, the set-top box 100 may include a program for decoding received data and may generate an output signal by encoding the data.

The set-top box 100 may transmit a user request signal acquired through, for example, the remote controller 120 to the media cloud server 300, receive image identification information of commerce content corresponding to the user request signal from the media cloud server 300, and request broadcasting video data (e.g., video on demand (VOD) data) corresponding to the image identification information from the content server 200. In some forms, the set-top box 100 may convert a subscriber's request (e.g., a user input through a remote controller) into a control signal and transmit the control signal to the media cloud server 300.

The set-top box 100 may transmit a user request signal received from a separate input device or the output device 101 to the media cloud server 300. The set-top box 100 may generate output data for broadcasting based on data received from the content server 200 and the media cloud server 300. In some forms, the set-top box 100 may transmit the output data controlled/generated by the media cloud server 300 to the output device 101 and control to display output data according to a user request signal through the output device 101.

Specifically, the set-top box 100 may receive first output data including a cover screen generated based on cover screen data from the media cloud server 300 through other transmission paths such as the network 500. The cover screen data include and correspond to a basic set of information relevant to one or more product codes including type and content of the information relevant to the product codes, configuration and layout of a cover screen to be generated, broadcast video contents linked to the product codes, a user input data, a preset playback time for each product code etc.

In addition, the set-top box 100 may receive second output data including a broadcasting video generated based on broadcasting video (video content) data from the content server 200 through an image transmission path on the network 500, and control the corresponding broadcasting video to be played through the output device 101.

The set-top box 100 may obtain a user input regarding a broadcast channel, a product code, or the like through the remote controller 120 communicating with the set-top box 100 or another user terminal.

The content server 200 performs a function of transmitting one or more broadcasters or broadcast content of a broadcast channel to the set-top box 100. The content server 200 may transmit content requested by each set-top box 100. The content server 200 may be implemented to broadcast and transmit content received from a content providing server to be described later.

In some forms, the TV, i.e., the output device 101 is a terminal connected to the set-top box 100 and may receive and output broadcast output data processed and/or generated in the set-top box 100. For example, if the output data is visual data, it may be displayed through a display unit (not shown) of the output device 101, or if the output data is voice data, it may be outputted in an audio format.

The media cloud server 300 may transmit content information corresponding to the output data to the set-top box 100. The media cloud server 300 may execute an application stored in the cloud server and display such an application while streaming it on the TV 101 such as a TV of each user. At this time, the TV 101 may be controlled through a program installed in the set-top box 100, and may output broadcast content or commerce content under the control of the set-top box 100. The set-top box 100 may be implemented to operate through instructions from the media cloud server 300.

The media cloud server 300 may drive and control an application based on a control signal transmitted from the set-top box 100. The media cloud server 300 may generate application screen data for the application. The media cloud server 300 may transmit the generated application screen data to the set-top box 100. For example, the media cloud server 300 may transmit the generated application screen data and image identification information (e.g., playback URL information) corresponding to the user's control signal to the set-top box 100 together.

The media cloud server 300 may generate broadcast output data based on data received from the data server 400. In some forms, the media cloud server 300 may receive product information, customer information, order information, and program information from the data server 400. Meanwhile, the media cloud server 300 may control the set-top box 100 through a program installed in the set-top box 100. The media cloud server 300 may perform a function of reading information of the set-top box 100. The media cloud server 300 may receive the platform code, STP ID, and access information of the set-top box 100. The media cloud server 300 may generate output data of the set-top box 100 based on information on the set-top box 100. The media cloud server 300 may regenerate broadcast output data in response to a user input acquired through the set-top box 100 and transmit the generated broadcast output data to the set-top box 100.

The media cloud server 300 may allow capture information including various contents such as operations, instead of information itself of contents as described above to be displayed on a screen of the TV 101 through the set-top box 100, through the cloud solution. In some forms, the media cloud server 300 may be implemented using a cloud server, and may control conversion of one or more first and second cloud servers. The media cloud server 300 may implement a screen in the TV 101 by driving an application corresponding to the selected channel through the first cloud server, and may accommodate a plurality of users through the first cloud server.

Additionally, or alternatively, the media cloud server 300 may be connected to the set-top box 100 to transmit second content according to a user input from the set-top box 100. The second content may include a cover screen corresponding to a user input. The second content may be a cover screen corresponding to the same user input by interlocking with and/or in association with the first content corresponding to the one user input. For example, the first content is selected on the content server 200 according to a user input selecting a product code and a product group channel, and the second content corresponding to the first content according to the user input may be generated on the media cloud server 300.

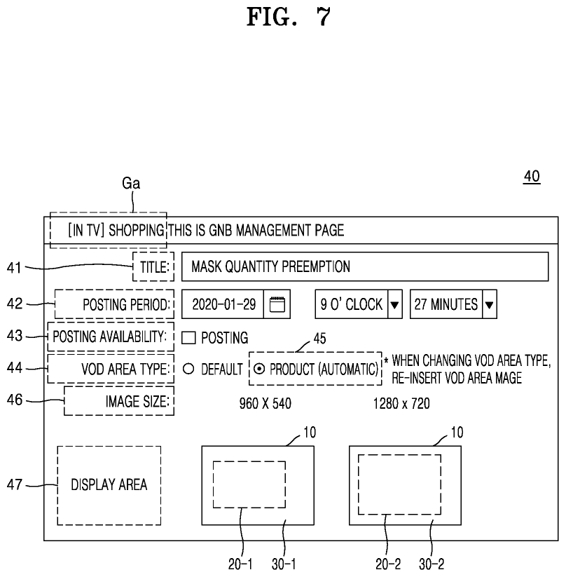

The user terminal 310 may be connected to the media cloud server 300 to control the media cloud server 300. Various items of TV output data for each user input may be set through a control screen on a display unit (not shown) of the user terminal 310. This will be described in more detail in FIG. 7 to be described later. The user terminal 310 may communicate with the broadcasting system 1000 through the network 500 and may be connected to the media cloud server 300 through a separate communication network.

The data server 400 is a server separate from the media cloud server 300, and may transmit product information, customer information, order information, and program information to the media cloud server 300. The data server 400 is a computing device in which a server program such as Apache Tomcat® or Oracle is installed, and may be implemented to process server functions.

The data server 400 may store and/or deliver sub-output data for supplementing and assisting the generation of output data generated by the media cloud server 300. The data server 400 may store and manage information for generating output data. The data server 400 is a computing device in which a server program such as Apache Tomcat® or Oracle is installed, and may be implemented to process server functions. As described above, the data server 500 may store product information, production information, and/or deliberation information including deliberation completion/progress status values of content. In addition, the data server 400 may store image identification information, pop-up data, and the like, and provide related information to the media cloud server 300 in response to a request from the media cloud server 300. At this time, the video identification information is used to call the broadcasting video data stored in the content server 200. The set-top box 100 may read the image identification information included in the output data received from the media cloud server 300, and receive a broadcasting video from the content server 200 to generate broadcast output data.

Meanwhile, the broadcasting system 1000 may further include a content providing server (not shown) that exchanges data with the content server 200.

The content providing server may register (e.g., obtain and store) content such as a commerce video to be provided through the broadcasting system 1000 according to an embodiment of the present disclosure. In addition, the content providing server may receive meta information of content such as video from the data server 400 and match the meta information for each content. Accordingly, the content providing server may be connected to the data server 400, and exchange various information with each other through communication.

The content providing server may convert content such as a registered video according to a platform or format of each broadcaster and transmit the converted content to the content server 200. The present disclosure is not limited thereto, and the content providing server stores the content and transmits the stored content to the content server 200, and the content server 200 may convert and store the corresponding content according to the platform or format of the broadcaster. This is consistently performed in the following embodiments and variations thereof.

Meanwhile, in some forms, the content providing server may obtain meta information of the content from the data server 400. The meta information may include product information, production information, and/or deliberation information related to the corresponding content. In other forms, the content providing server may directly receive and store meta information from a content provider.

The content providing server may transmit content data such as video or converted content data to the content server 200 through a distributed network (e.g., CDN). In addition, the content providing server may receive image identification information of each video from the content server 200. The image identification information may be, for example, playback URL information stored in the content server 200. The commerce contents registered in the content providing server may be provided to subscribers as video on demand (VOD).

The network 500 may be defined as one or more data links capable of transmitting and receiving data between electronic devices and/or servers, and may be a wired and/or wireless communication network. For example, the network 500 may be a content delivery network (CDN) capable of efficiently delivering various user-selectable content. As another example, the network 500 may be at least one short-range wireless communication network among wired communication networks such as the Internet, WiFi, Bluetooth, Bluetooth Low Energy and Zigbee, and Ultra Wide Band (UWB), but is not necessarily limited to this.

In this way, the broadcasting system 1000 may generate output data by using the content server 200 and the media cloud server 300 communicating with the set-top box 100 so that it is possible to distribute the network load and implement broadcasting including various information in a fast and real-time manner.

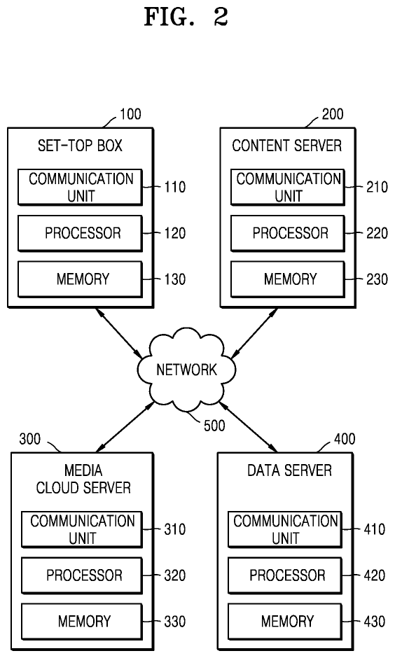

FIG. 2 is a diagram showing in more detail some configurations of a broadcasting system according to an embodiment of the present disclosure.

Each of the set-top box 100, the content server 200, the media cloud server 300, and the data server 400 may include communication units 110, 210, 310, and 410, processors 120, 220, 320, and 420, and memories 130, 230, 330, and 430, respectively.

The communication units 110, 210, 310, and 410 may communicate with various types of external devices and servers according to various types of communication methods. The communication units 110, 210, 310, and 410 of the present disclosure are connected by the network 500 to exchange data with each other, but the present disclosure is not limited thereto. In other forms, some of the components 100, 200, 300, and 400 may be connected to and communicated with a separate network.

The processors 120, 220, 320, and 420 may perform an operation of controlling each device or the servers 100, 200, 300, and 400 including each memory using various programs stored in the memories 130, 230, 330, and 430. The processors 120, 220, 320, and 420 may include a processing device such as a microprocessor, a Central Processing Unit (CPU), a processor core, a multiprocessor, an Application-Specific Integrated Circuit (ASIC), a Field Programmable Gate Array (FPGA), and the like, but is not limited thereto.

The memories 130, 230, 330, and 430 perform a function of temporarily or permanently storing data processed by each device or the servers 100, 200, 300, and 400 including each memory. The memories 130, 230, 330, and 430 may include a random access memory (RAM), a read only memory (ROM), and a permanent mass storage device such as a disk drive, but the scope of the present disclosure is not limited thereto.

In some forms, the processor 120 of the set-top box 100 may acquire and receive a user input through the communication unit 110 and request output data corresponding to the user input. The processor 120 may generate first output data including a cover screen generated based on the cover screen data received from the media cloud server 300 and transmit the first output data to the TV 101. In addition, the processor 120 generates second output data including broadcasting video generated based on the broadcasting video data received from the content server 200 and transmitted to the TV 101. The processor 120 of the set-top box 100 may generate the first output data and the second output data based on an output data condition set through the media cloud server 300.

In other forms, the first output data and the second output data may be generated by the processor 320 of the media cloud server 300. For example, the second output data may include various commerce contents based on application screen data generated by the media cloud server 300 in addition to the broadcasting video received from the content server 200.

The processor 320 of the media cloud server 300 may receive the request of the set-top box 100 through the communication unit 310 and in response thereto, generate the cover screen data and/or the cover screen based on the cover screen data. According to an embodiment, the processor 320 may generate the first output data including the cover screen and transmit the first output data to the set-top box 100.

The processor 220 of the content server 200 may receive the request of the set-top box 100 through the communication unit 210 and select the broadcasting video data in response thereto. The above-described sub-output data may be stored in the memory 430 of the data server 400, and the sub-output data may be transmitted to the media cloud server 300 through the communication unit 410.

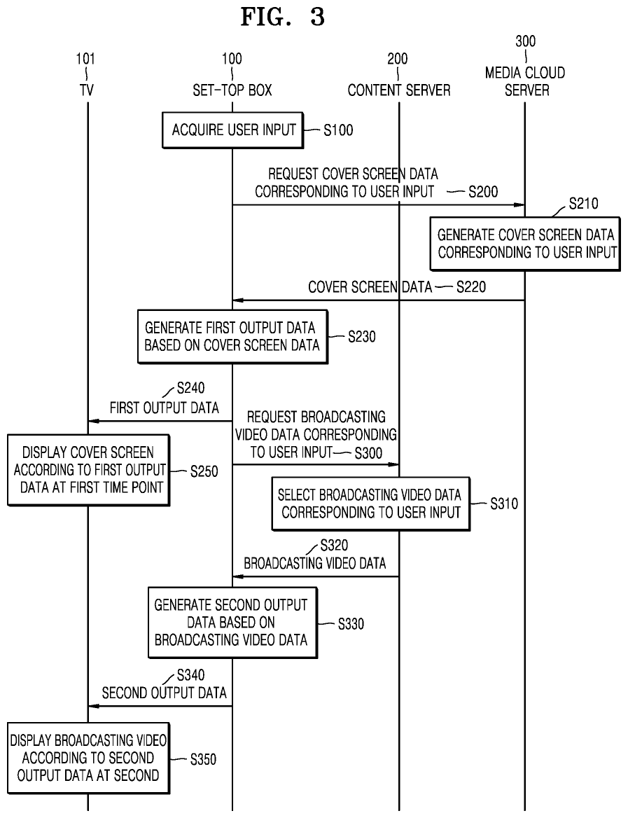

FIG. 3 is a flowchart illustrating a method of operating a broadcasting system according to an embodiment of the present disclosure.

The set-top box 100 may acquire a user input (S100). Thereafter, the set-top box 100 may request cover screen data corresponding to the user input and broadcasting video data corresponding to the user input (S200 and S300). Hereinafter, an embodiment in which step S200 is performed first, and then step S300 is performed will be described as an example.

The set-top box 100 may request cover screen data corresponding to the user input from the media cloud server 300 (S200). In response to the request, cover screen data corresponding to the user input may be generated using the media cloud server 300 (S210). Thereafter, the cover screen data may be transmitted to the set-top box 100 (S220).

The set-top box 100 may generate first output data based on the cover screen data received from the media cloud server 300 (S230), and transmit the first output data to the TV 101 (S240). The TV 101 may receive the first output data and display a cover screen according to the first output data in a first area of the TV screen at a first time point (S250, a first output step). Hereinafter, steps S200, S210, S220, S230, and S240 may be collectively referred to as ‘step S2’.

The set-top box 100 may request broadcasting video data corresponding to the user input from the content server 200 (S300). In response to the request, broadcasting video data corresponding to the user input may be selected by the content server 200 (S310). The broadcasting video data may be transmitted to the set-top box 100 (S320).

The set-top box 100 may generate second output data based on the broadcasting video data received from the content server 200 (S330), and transmit the second output data to the TV 101 (S340). The TV 101 may receive the second output data and play a broadcasting video according to the second output data in the first area of the TV screen at a second time point later than the first time point at which step S250 is performed (S350, a second output step). Hereinafter, steps S300, S310, S320, S330, and S340 may be collectively referred to as ‘step S3’.

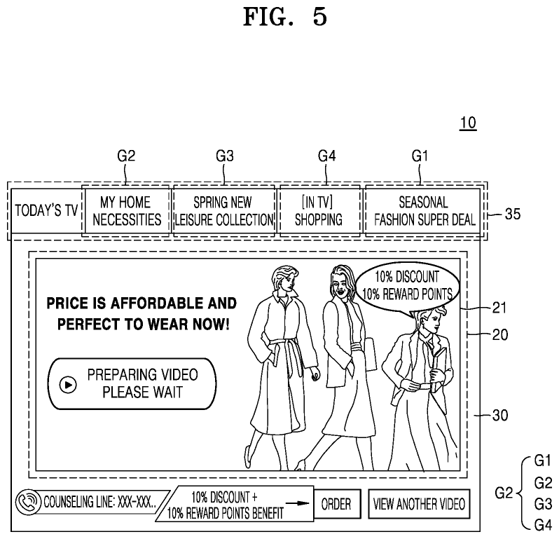

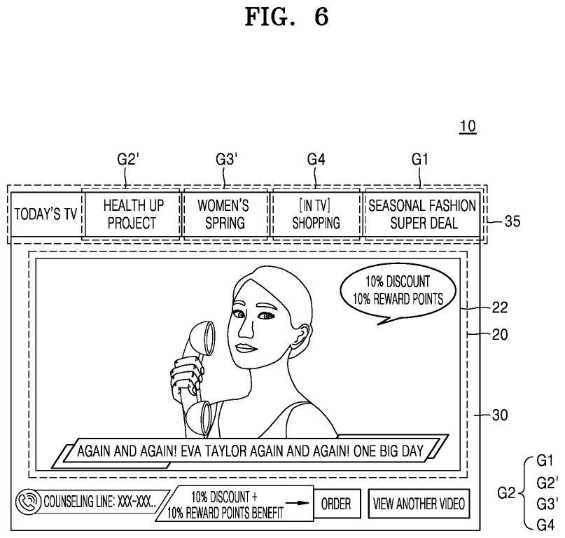

When the set-top box 100 acquires a changed user input while performing any one of the first output step S250 and the second output step S350, the above-described steps S100, S2, S250, S3, and S350 according to the changed user input may be repeated. According to an embodiment, the input is not changed according to the user's operation, but the cover screen and the broadcasting video corresponding thereto may be automatically played sequentially or randomly according to a preset output data condition. This will be described in more detail in FIGS. 5 and 6 to be described later.

In the above, it has been described that step S300 is performed after step S200, but the present disclosure is not limited thereto. In other forms, steps S200 and S300 may be performed simultaneously, or step S200 may be performed after step S300 is performed first. In other words, as long as step S350 is performed after step S250, steps S2 (steps S200, S210, S220, S230, and S240) and steps S3 (steps S300, S310, S320, S330, and S340) may be performed in parallel regardless of the order.

As such, according to embodiments of the present disclosure, by using, as a server that communicates with the set-top box 100, the content server 200 and also the media cloud server 300 that is distinguished therefrom, data load on the network 500 can be distributed and a cover screen and a broadcasting video corresponding thereto may be automatically generated according to a user input.

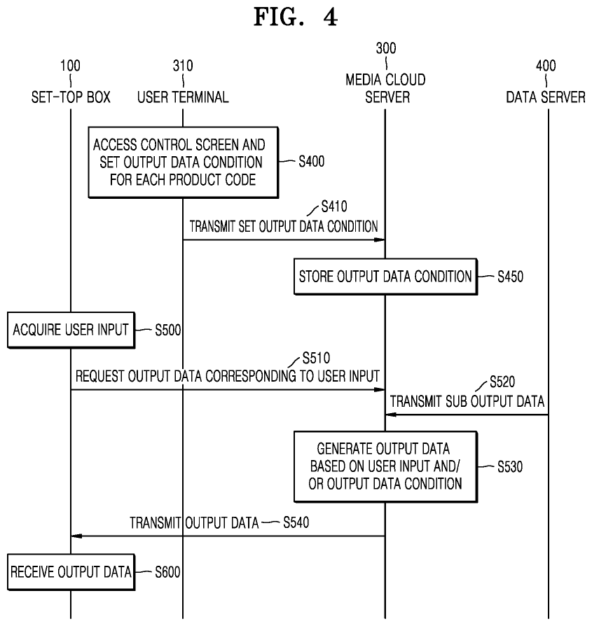

FIG. 4 is a flowchart illustrating a method of operating a broadcasting system according to another embodiment of the present disclosure. With reference to FIG. 4, an operation method between a user terminal 310 and a media cloud server 300 will be mainly described.

The broadcasting system 1000 may include the set-top box 100, the user terminal 310, the media cloud server 300, and the data server 400, as described in connection with FIG. 1.

The user terminal 310 may transmit and receive information through a network with the media cloud server 300, and may control various elements of output data of the media cloud server 300.

For example, it is possible to control the output data of the media cloud server 300 by accessing the media cloud server control screen (hereinafter, simply named as ‘control screen’ and described) through the user terminal 310 (S400). According to an embodiment, output data outputted to a TV screen through a server other than the media cloud server 300 by way of the control screen 40 may also be controlled. The control screen may be a screen displayed on a display unit included in the user terminal 310. One form of the control screen 40 is shown in FIG. 7 to be described later.

More specifically, the output data is allocated to a product code and a product group channel (hereinafter, collectively referred to as product code) in which similar product groups are grouped, and output data for each product code may be different from each other. Controlling the output data may be setting an output data condition for each product code. The product code may be an item selected as a user input, and may be automatically changed after a preset time elapses without a user input. As an example, the product code may be sale product information corresponding to different user interfaces (“U Is”) with reference to FIGS. 5 and 6 to be described later.

The output data may include the above-described first output data and second output data. The first output data include cover screen data and may output a cover screen corresponding to a user input, and the second output data may be broadcasting video data and may output a broadcasting video corresponding to user input. The output data condition will be described in more detail in FIG. 7 to be described later.

Thereafter, the output data condition set through the user terminal 310 may be transmitted to the media cloud server 300 using a network (S410). The network may be the same as or different from the network 500 described with reference to FIGS. 1 and 2.

In the process of generating the first output data and the second output data using the media cloud server 300, the output data may be generated based on a user input and/or the output data condition (S530).

In this case, the media cloud server 300 may receive sub-output data from the data server 400 (S520). When step S520 is performed, in step S530, output data may be generated by considering not only the user input and/or output data conditions, but also the sub-output data received in step S520.

The media cloud server 300 may transmit the output data to the set-top box 100 (S540). Thereafter, the set-top box 100 may receive the output data (S600), and transmit the output data to the TV 101 to display the first content, the second content, or a combination of the first content and the second content according to the output data through the TV 101. According to an embodiment, the set-top box 100 may process the output data received from the media cloud server 300 and reproduce the output data by itself.

In some forms, an error may occur while outputting the output data generated by the media cloud server 300 or the set-top box 100 to the TV 101, thereby generating ‘false output data’. The data to be originally output is called ‘reference output data’. In relation to ‘false output data’, output data of a product code other than the selected product code is displayed on the TV screen, or output data of the selected product code is displayed but some UIs of the output screen may be displayed as different UIs. For example, a 1-2 UI may be displayed on the cover screen of the first product code instead of a 1-1 UI, which is the original data. In this case, a user, a server, and the like may compare the 1-2 UI of false output data and the 1-1 UI of the reference output data to determine whether the 1-2 UI and the 1-1 UI match each other. Thereafter, if the 1-2 UI and the 1-1 UI do not match each other, feedback may be given for modification to output the 1-1 UI instead of the 1-2 UI and re-output it through the control screen 40 for the media cloud server 300.

In this way, it is possible to control condition setting, feedback, and the like for output data through the TV 101 using the media cloud server 300.

FIG. 5 is an exemplary diagram of output data of a first time point generated by a broadcasting system according to an embodiment of the present disclosure. Hereinafter, descriptions provided in connection with FIGS. 1-4 may be simplified or omitted.

Referring to FIG. 5, a TV screen 10 in which the TV 101 displays content according to output data received from the set-top box 100 is shown.

The TV screen 10 includes a first area 20 and a second area 30 adjacent to the first area 20. The first area 20 is a main area of the TV screen 10 and may be a portion in which the cover screen 21 according to the first output data is displayed. The cover screen 21 may be displayed on the first area 20 of the TV screen 10 at the first time point. The cover screen 21 may be automatically displayed on the first area 20 according to a user input and/or a preset playback time for each product code.

The second area 30 is a peripheral area of the TV screen 10, and various information related to broadcasting, such as product information, customer information, order information, event information, and program information, may be displayed in the form of a user interface. For example, the second region 30 may include a GNB area 35. GNB is an abbreviation of “global navigation bar”, and may represent a menu that may be commonly used regardless of which output data is displayed in a display area of a user interface device such as the TV screen 10 of the present disclosure.

The GNB area 35 may display at least one user interface (UI) group G.

Two or more UIs may be included in the UI group G is at least two. As illustrated In FIG. 5, the UI displayed on the GNB area 35 to have four different UIs, i.e., first, second, third, and fourth UIs G1, G2, G3, and G4, but it is not limited thereto.

Each of the first to fourth UIs G1, G2, G3, and G4 may correspond to UI data including different product codes, similar product groups classified according to specific criteria, and similar/different product groups classified according to a specific theme. Each of the UIs G1, G2, G3, and G4 may be selected according to a user input, or may be automatically changed and selected according to a preset output data condition.

FIG. 6 is an exemplary diagram of output data of a second time point generated by the broadcasting system according to an embodiment of the present disclosure. The second time point is different from the first time point at which the output data is generated by the broadcasting system. Description provided in connection with FIG. 5 will be simplified or omitted.

The first area 20 is a main area of the TV screen 10, and not only the cover screen 21 according to the above-described first output data but also the broadcasting video 22 according to the second output data may be displayed in the first area 20. The broadcasting video 22 may be played in the first area 20 at the second time point that is later than the first time point in one form. The broadcasting video 22 may be automatically played in the first area 20 according to a user input and/or a preset playback time for each product code. The broadcasting video 22 may correspond to a cover screen 21 according to a user input. In other words, when the cover screen 21 is selected according to the user input, the broadcasting video 22 corresponding thereto may be automatically selected and played.

The second area 30 may display at least one UI group G in the GNB area 35. In the exemplary embodiment of FIG. 6, the UI group G is illustrated as having 4 of the first, second′, third′, and fourth UIs G1, G2′, G3′, and G4, but the number of UIs displayed in the GNB area 35 is not limited thereto. In the same way, each of the first, second, third, and fourth UIs G1, G2′, G3′, and G4 may correspond to UI data including different product codes, similar product groups classified according to specific criteria, and similar/different product groups classified according to a specific theme. Each of the UIs G1, G2′, G3′, and G4 may be selected according to a user input, or may be automatically changed and selected according to a preset output data condition.

Referring to FIGS. 1 and 5 together, when the first UI G1 is selected according to a user input, the set-top box 100 may request cover screen data corresponding to the user input from the media cloud server 300. The media cloud server 300 may generate cover screen data corresponding to the first UI G1 in response to the request and transmit the generated cover screen data to the set-top box 100 again. The set-top box 100 may generate first output data based on the cover screen data, and the TV 101 may display the cover screen 21 according to the first output data at the first time point.

Meanwhile, the set-top box 100 may request broadcasting video data corresponding to the user input to the content server 200. The content server 200 may generate broadcasting video data corresponding to the first UI G1 in response to the request and transmit the generated broadcasting video data to the set-top box 100 again. The set-top box 100 may generate second output data based on the broadcasting video data, and the TV 101 may play the broadcasting video 22 according to the second output data at a second time point that is later than the first time point.

As described above, while the cover screen 21 and the broadcasting video 22 corresponding to the user input selecting the first UI G1 are displayed, when the fourth UI G4 is selected according to the changed user input, in the same way, the cover screen 21 and the broadcasting video 22 corresponding to the fourth UI G4 may be displayed in the same manner as described above. According to an embodiment, UIs are not selected through user input, but according to the output data condition set through the control screen 40 for the media cloud server 300 of FIG. 7 to be described later, automatically switching between different UIs (e.g., G1, G2, G3, and G4) may be performed. This will be described in more detail in FIG. 7 to be described later.

FIG. 7 is an exemplary diagram of a control screen 40 for the media cloud server 300. Hereinafter, a method of controlling output data on the TV 101 using the user terminal 310 will be described.

The control screen 40 may be displayed on the display unit of the user terminal 310 communicating with the media cloud server 300. Hereinafter, a user who controls the user terminal 310 may be named and described as a second user. The second user may be different from or the same as the user who changes the user input regarding the output data of the TV screen 10 described above.

The second user may access the control screen 40 through the user terminal 310. Output data conditions for each product code may be set through the control screen 40. The output data may include first output data for outputting the above-described cover screen 21 and second output data for outputting the broadcasting video 22. When generating the first output data and the second output data, they may be generated based on the output data condition. Hereinafter, the output data conditions will be described in more detail.

A condition for output data corresponding to any one UI Ga selected from the UI group G may be set through the control screen 40. Ga may be any one UI selected from the above-described UI group G. The output data condition may include a title 41, a posting period 42, a posting availability 43, a VOD area type 44, an image size (or resolution) 46, and a display area 47, but is not limited thereto, and may include various items not shown in FIG. 7.

First, the title 41 for an output page corresponding to Ga (hereinafter, it may be described as “10a”) may be set. The text of the title to be displayed may be inputted and set, and although not shown in the drawing, the font, size, and position of the text may be set. The posting period 42 such as a posting date and time of the output page 10a may be set, and specifically, a posting period of each of the cover screen 21 and the broadcasting video 22 corresponding to Ga may be set. By setting the posting period 42, it is possible to switch between different UIs without changing the UI (e.g., G1, G2, G3, and G4) according to a user input. For example, when the posting period 42 in which the output data corresponding to the first UI G1 is displayed has elapsed, the second UI G2, which is another UI, may be automatically selected, and output data according to the second UI G2 may be displayed.

The posting availability 43 may be selected, and only product codes to be posted on the TV screen 10 may be selected and displayed. The VOD area type 44 may be selected, and when the product (automatic) mode 45 is selected, an image of a product included in Ga may be displayed. The VOD area type 44 is not limited to that shown in FIG. 7, and various images related to the corresponding product may be selected. The image size (or resolution) 46 of the cover screen 21 and/or the broadcasting video 22 according to the output data may be set.

The display area 47 may be set through the control screen 40. The first area 20 and the second area 30 of the TV screen 10 may be determined according to the setting of the display area 47. For example, the first area 20-1 and the second area 30-1 according thereto may be selected according to the selected image size (960×540), and when a different image size (1280×720) is selected, the first area 20-2 and the second area 30-2 according to the corresponding size may be selected. At this time, the location of the first areas 20-1 and 20-2 on the TV screen 10 may also be set, and UIs displayed in the second areas 30-1 and 30-2 and their arrangement may be determined.

According to embodiments of the present disclosure, when a cover screen according to a user input and a broadcasting video corresponding thereto are automatically generated, data load on a network may be distributed by using a server different from a set-top box.

It should be understood that embodiments described herein should be considered in a descriptive sense only and not for purposes of limitation.

Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method of operating a broadcasting system, the method comprising:
obtaining a user input;
requesting cover screen data corresponding to the user input and broadcasting video data corresponding to the user input;
generating the cover screen data with a media cloud server; and
selecting the broadcasting video data with a content server.

2. The method of claim 1, further comprising:
generating first output data including a cover screen generated based on the cover screen data received from the media cloud server; and
generating second output data including a broadcasting video generated based on the broadcasting video data received from the content server.

3. The method of claim 2, further comprising:
a first output step of displaying the cover screen according to the first output data on a TV screen at a first time point; and
a second output step of displaying the broadcasting video according to the second output data on the TV screen at a second time point temporally later than the first time point.

4. The method of claim 2, further comprising:
accessing a control screen through a user terminal; and
setting an output data condition for each product code through the control screen,
wherein generating the first output data further comprises generating the first output data based on the output data condition; and
generating the second output data further comprises generating the second output data based on the output data condition.

5. A method of operating a broadcast system comprising:
generating cover screen data with a media cloud server, in response to a user input obtained from a set-top box, or in response to an output data condition;
transmitting the cover screen data to the set-top box with the media cloud server;
selecting broadcasting video data with a content server;
transmitting the broadcasting video data to the set-top box with the content server; and
broadcasting a cover screen based on the cover screen data and a broadcasting video based on the broadcasting video data.

6. The method of claim 5, further comprising:
controlling the cover screen data by accessing a media cloud server control screen, regardless of the user input.

7. The method of claim 5, wherein generating the cover screen data further comprises generating the cover screen data in response to a product code, wherein the product code is included as an item selected by the user input, or the product code automatically changes after a preset time elapses without a user input based on the output data condition.

8. The method of claim 5, further comprising:
generating, at the media cloud server, first output data including a cover screen based on the cover screen data; and
generating, at the media cloud server, second output data including a broadcasting video based on the broadcasting video data received from the content server.

9. The method of claim 5, further comprising automatically selecting and playing the broadcasting video upon selection of the cover screen.

10. The method of claim 5, further comprising transmitting to and receiving from a user terminal, information relevant to the output data condition, at the media cloud server.

11. The method of claim 10, further comprising displaying a media cloud server control screen on a display device of the user terminal.

12. The method of claim 11, further comprising:
setting the output data condition through the user terminal;
transmitting the output data condition to the media cloud server; and
generating first output data and second output data based on the output data condition at the media cloud server.

13. A broadcasting system that automatically generates a cover screen and a broadcasting video, the broadcasting system comprising:
a set-top box configured to acquire a user input and request cover screen data corresponding to the user input and broadcasting video data corresponding to the user input;
a media cloud server configured to generate the cover screen data in response to the request; and
a content server configured to select the broadcasting video data in response to the request.

14. The broadcasting system of claim 13, wherein the set-top box outputs:
first output data including a cover screen generated based on the cover screen data; and
second output data including a broadcasting video generated based on the broadcasting video data.

15. The broadcasting system of claim 14,
wherein the set-top box, through an output device connected to the set-top box,
controls to display the cover screen according to the first output data in a first area at a first time point, and
automatically generates a cover screen and a broadcasting video for controlling to display the broadcasting video according to the second output data in the first area at a second time point later than the first time point.

16. The broadcasting system of claim 14, wherein the media server is further configured to set an output data condition for each product code.

17. The broadcasting system of claim 14, wherein the media cloud server is further configured to generate the first output data and the second output data.

18. The broadcasting system of claim 16, wherein the set-top box generates the first output data and the second output data based on the output data condition.

19. The broadcasting system of claim 13, wherein the media server is further configured to receive an output data condition that is set via a control screen displayed on a user terminal.

20. The broadcasting system of claim 19, wherein the media cloud server is further configured to generate the cover screen data based on the output data condition.
